(19) United States
(12) Patent Application Publication
(10) Pub. No.: US 2003/0152807 A1
(43) Pub. Date: Aug. 14, 2003

(54) Tape-like magnetic medium

(75) Inventors: Jens Soder, Gottingen (DE); Hansjorg Traub, Willstatt (DE); Jurgen Keske, Neuried (DE); Wolfgang Neumann, Neuried (DE); Edgar Genter, Buhl (DE)

Correspondence Address: GREENBLUM & BERNSTEIN, P.L.C., 1950 ROLAND CLARKE PLACE, RESTON, VA, 20191, US

(73) Assignee: EMTEC Magnetics GmbH, Ludwigshafen (DE)

(21) Appl. No.: 10/277,149

(22) Filed: Oct. 22, 2002

(30) Foreign Application Priority Data
Oct. 23, 2001 (DE) 101 52 287.8

(51) Int. Cl. G11B 5/72

(52) U.S. Cl. 428/694 TP; 428/695; 428/694 BP

(57) ABSTRACT

A tape-like magnetic medium comprising a flexible substrate and a magnetic layer thereon which comprises magnetic pigment and polymeric binder. The magnetic layer has a thickness of at least 3 μm and a specific surface porosity of at least 80 cm²/cm². Also provided are a production process for the medium and a high-speed process for the production of a copy of a magnetic master tape.

### CROSS-REFERENCE TO RELATED APPLICATIONS

The present application claims priority under 35 U.S.C. §119 of German Patent Application No. 101 52 287.8, filed on Oct. 23, 2001, the disclosure of which is expressly incorporated by reference herein in its entirety.

### BACKGROUND OF THE INVENTION

1. Field of the Invention

The present invention relates to a magnetic medium comprising a flexible substrate and at least one magnetic layer which is applied to one side of said substrate and in which magnetic pigments finely distributed in a polymeric binder are embedded, a process for the production of such a medium and its use as a master tape in a magnetic copying process.

2. Discussion of Background Information

Magnetic recording media are produced in various compositions for a large number of intended uses, for example for audio or video recordings, for the recording of data or for copying processes. They are made available commercially either as tape-like media, as floppy disks or as cards. In order to achieve a very high recording density, the magnetizable particles must be present in the layer in a very high packing density which is from about 70 to 90% by weight; the magnetic pigments should also be present in very finely divided form.

The widespread use of home video appliances has considerably increased demand for prerecorded cassettes, for example half-inch video cassettes of the VHS type. In order to satisfy this demand in an economical manner, it is necessary to produce in a short time from a master tape, which carries the desired magnetic information, a large number of copy tapes which contain the information copied from the master tape. The production of such cassettes is not particularly simple since master tape, copy tape and the apparatuses used for the copying process have to meet a number of requirements in order for the copy tapes to have an appropriate image quality.

A real-time duplication process widely used a while ago comprised transferring the original recording from the master tape on a conventional video recorder in the system-defined time frame, i.e. about 2-3 cm/s, to a large number of duplicating recorders, each of which contained a copy tape. The long time and the required logistics made this method a very expensive process.

Two fast-copying processes, the thermomagnetic and the anhysteretic method, in which the master tape and the copy tape pass together over a duplicating means, with close contact between the two magnetic layers, at high speed which is of the order of magnitude of from 4 to 10 m/s, have become established on the market, magnetic information being transferred from the master tape to the copy tape in this way. For this purpose, the master tape must contain information recorded as a mirror image (mirror master), which information is then transferred laterally correctly to the copy tape in the fast-copying process.

In the thermomagnetic method, a highly focused energy beam, for example a laser beam, is applied to the back of the copy tape during the contact time and heats the copy tape above the Curie temperature, after which the copy tape must be cooled again. In this case, of course, the master tape must have a substantially higher Curie temperature so that its own magnetic information does not suffer as a result.

In the anhysteretic method, an external magnetic field acts on the copy tape during the contact time and thus effects transfer of the magnetic information. In order to ensure also in this case that the master tape is not damaged in information content by this procedure, the strength of the external magnetic field may not be more than one third to one half of the coercive force of the master tape.

Substantially two types of fast-copying apparatuses are currently in use on the market, which apparatuses operate according to the anhysteretic method. One apparatus is the loop sprinter, for example offered by Sony under the designation HSP 800. Here, the master tape is transported past the copy tape in an endless loop, thus permitting a continuous copying process. The other apparatus is the shuttle sprinter, which is sold, for example, by Sony under the designation HSP 5000, in which the master tape is rewound after completing a copying operation, whereafter the next copying operation starts.

The Applicants have found that both the above-described sprinters and thermomagnetic copying apparatuses give rise to the following disturbances which lead to errors in the copying process:

An air cushion may remain between the magnetically coated sides of the copy tape and of the master tape owing to the fast copying process, and due to this air cushion a reduced signal is transferred to the copy tape.

This effect is enhanced if a dirt particle is present at a corresponding point on the surface of the printwheel. The transfer is then disturbed by the tent effect so that the copy tape has a dropout at this point.

In the case of the shuttle sprinter, in which the drive tape provides the only drive, the surface properties of the tapes involved must be such that there is no slipping between them.

DE-A-41 38 267, the disclosure of which is expressly incorporated by reference herein in its entirety, discloses a magnetic medium in which a master tape permits a large number of runs when the lubricant distribution in the master and copy tapes fulfills specific values.

EP-A-0 702 359, the disclosure of which is expressly incorporated by reference herein in its entirety, discloses a magnetic recording medium which is said to have a porosity of at least 0.4 m²/g and to be suitable for recording at high storage density. The substrate has a maximum thickness of 9 μm, with a total thickness of up to 11 μm. On conversion to the respective layer thickness, the known medium has a very low specific surface porosity (SSP), i.e., about 3 cm²/cm² at a layer thickness of 2.5 μm.

Accordingly, it would be desirable to provide a magnetic medium of the type stated at the outset which, when used as the master tape, leads to no or substantially less dropout on the copy tape (in particular in the case of soiling of the printwheel which occurs during normal operation). The tape also is to have an improved life, permitting multiple use as a master tape without suffering of the transfer properties when the copying process is repeated. Slipping between master and copy tapes during use as a master tape in the shuttle sprinter system also should be avoided.

### SUMMARY OF THE INVENTION

The present invention provides a tape-like magnetic medium which comprises a flexible substrate and at least one magnetic layer on one side of the substrate. The magnetic layer comprises magnetic pigment and polymeric binder and has a thickness d_{M} of at least 3 μm and a specific surface porosity SSP of at least 80 cm²/cm², the SSP being the specific nitrogen adsorption per volume element, according to BET, of the magnetic layer (in cm²/cm³) multiplied by the thickness d_{M} of the magnetic layer (in cm).

In one aspect, the SSP of the magnetic layer is at least 90 cm²/cm². In another aspect, it does not exceed 200 cm²/cm², e.g., is not higher than 180 cm²/cm². In yet another aspect, the thickness d_{M} of the magnetic layer does not exceed 8 μm. For example, the thickness d_{M} may range from 4 to 5.5 μm.

In still another aspect, the substrate has a thickness d_{T} of at least 15 μm. In a further aspect, d_{T} does not exceed 30 μm.

In yet another aspect of the tape-like magnetic medium according to the present invention, the average peak-to-valley height R_{z} on the side of the substrate which does not carry the at least one magnetic layer is 200 to 400 nm.

According to a further aspect, the side of the substrate of the tape-like magnetic medium which does not carry the magnetic layer carries a backing coating. The backing coating comprises pigment and polymeric binder and, in one aspect, has an average peak-to-valley height R_{z} of at least 200 nm. In another aspect, Rₐ does not exceed 400 nm. The backing coating may have a thickness d_{R} of at least 0.5 μm, but not higher than 5 μm. For example, d_{R} may range from 0.7 to 4 μm.

In still another aspect of the tape-like magnetic medium of the invention, the magnetic pigment is selected from metallic pigments, alloy pigments and mixtures thereof. The magnetic pigments usually comprise at least one of Fe, Ni and Co, and may additionally comprise at least one of Al, Si, S, Sc, Ti, V, Cr, Cu, Y, Mo, Pd, Rh, Ag, Sn, Sb, Te, Ba, Ta, W, Re, Au, Hg, Pb, Bi, La, Ce, Pr, Nd, P, Mn, Zn, Co, Ni, Sr and B. The magnetic pigments often have a BET surface area of 40 to 90 m²/g and/or a coercive force of at least 100 kA/m and/or a saturation magnetization of 100 to 180 emu/g.

In a further aspect, the polymeric binder of the magnetic layer comprises at least one polymer which has a glass transition temperature, Tg, which is lower than 60° C. and at least one polymer having a Tg which is higher than 60° C.

The magnetic layer may further comprise a nonmagnetic pigment, e.g., a pigment selected from carbon black, metal oxides, metal carbonates, metal sulfates, metal nitrides, metal carbides, metal sulfides and combinations thereof.

The present invention also provides a process for the production of the above tape-like magnetic medium. The processes comprises applying a magnetic coating composition comprising magnetic pigment and polymeric binder onto one side of a flexible substrate and drying the coating. The resultant material may be subjected to calendering between pressure rolls at a pressure not exceeding 110 bar.

In one aspect of the process, the calendering pressure is at least 90 bar. The nip pressure of the pressure rolls usually is not higher than 250 daN/cm, and not lower than 210 daN/cm.

In another aspect, the process further comprises the application of a backing coating onto the other side of the flexible substrate. It may also comprise the orientation of the magnetic coating.

In yet another aspect, the pressure rolls are heated, the temperature thereof being not higher than 95° C.

The present invention further provides a process for the production of a copy of a magnetic recording medium having information recorded thereon. In this process, a master tape comprising a magnetic layer and having information recorded thereon and a copy tape comprising a magnetic layer are passed, at a speed of at least about 4 m/s and with contact of the magnetic layers with one another, over a copying device. The copy tape is heated above its Curie temperature to copy information recorded on the master tape onto the copy tape. Alternatively, an external magnetic field whose strength is not higher than half of the coercive force of the master tape is applied to the master tape and the copy tape to copy information recorded on the master tape onto the copy tape.

In one aspect of the process, the speed is in the range of 4 to 10 m/s. In another aspect, the copying device in the case of the application of an external magnetic field comprises a loop sprinter or a shuttle sprinter.

In yet another aspect of the process, the master tape used therein comprises the tape-like magnetic medium provided by the present invention and discussed above.

As stated above, the present invention provides a tape-like magnetic medium of the type discussed at the outset, in particular a master tape, in which the thickness of the magnetic layer is at least 3 μm, preferably 3 to 8 μm, wherein the medium/magnetic tape has a specific surface porosity SSP of at least 80, preferably at least 90 cm²/cm², the SSP being defined as specific nitrogen adsorption per volume element, according to BET, of the magnetic layer (in cm²/cm³) multiplied by the layer thickness of the magnetic layer (in cm). In this regard, it should be understood that the numerical values for thickness, SSP, temperature, pressure, concentration, etc. given herein and in the appended claims are approximate values, i.e., unless stated otherwise, are not limited to the exact recited values.

The stated SSP values are the values determined for the entire medium. However, the substrate and any backing coating, if present, make only a negligibly small contribution to the porosity, if any at all. The SSP values, therefore, characterize the porosity of essentially the magnetic layer.

Magnetic recording media in which the thickness of the flexible substrate is at least 15 μm and not more than 30 μm, e.g. about 25 μm, are preferred according to the invention. Substrate thicknesses smaller than 15 μm may result in inadequate running properties of the master tape, while excessively large layer thicknesses of more than 30 μm may result in a tape which is too stiff so that the tent effect described above causes a deterioration in the dropout values.

Other preferred media contemplated by the present invention are those whose second side, i.e., the side which is not provided with a magnetic coating, has an average peak-to-valley height R_{z}, measured using a perthometer, of at least 200 nm and not more than 400 nm, e.g. about 250 nm, or has a backing coating thereon, preferably having a dry thickness of from 0.5 to 5 μm, which has an average peak-to-valley height R_{z} of at least 200 nm and not more than 400 nm, e.g. about 235 nm.

The present invention furthermore relates to a process for the production of a novel magnetic medium of the type described above, wherein a magnetic layer and, optionally, a backing coating are applied, in each case in a conventional manner, to the substrate, the magnetic layer optionally is oriented and dried, and the coated and dried recording medium is subjected to a calendering operation, preferably between pressure rolls, the specific pressure being not more than 110 bar (or the nip pressure being not more than 250 daN/cm (decanewton per centimeter)). The calendering temperature of the heated pressure rolls is preferably not higher than 95° C.

The present invention finally relates to the use of the novel magnetic media as a master tape in a fast-copying process for the preparation of copies of magnetic recording media with information recorded thereon, wherein master tape and copy tape are passed, with contact of the respective magnetic layers with one another, at high speed over a copying means, and wherein the magnetic information of the master tape is transferred to the copy tape by heating the copy tape above its Curie temperature.

A variant of the novel use relates to the use of the magnetic media as a master tape for the preparation of copies of magnetic recording media with information recorded thereon, wherein master tape and copy tape are passed, with contact of the respective magnetic layers with one another, at high speed over a copying device, and wherein the magnetic information of the master tape is transferred to the copy tape while an external magnetic field whose strength is not more than half the coercive force of the master tape acts on the master tape and the copy tape.

### DESCRIPTION OF PREFERRED EMBODIMENTS

a. Substrate

The substrate predominantly comprises an organic polymer. Examples of organic polymers are polyesters, such as polyethylene terephthalate and naphthalate, polyolefins, cellulose derivatives, vinyl polymers and plastic materials such as, e.g., polycarbonate and polyimide.

The preferred thickness d_{T} of the substrate is, according to the invention, 15-30 μm. A substrate thickness smaller than 15 μm may result in inadequate running properties of the master tape; a thickness of more than 30 μm may result in a tape which is too stiff so that the tent effect causes a deterioration of the dropout values. The average peak-to-valley height R_{z} of the substrate is advantageously in the region of 100 nm. However, if the magnetic medium is to be used for copying processes with the shuttle sprinter described above, it is expedient for the second side of the substrate, which side does not carry the magnetic coating, to have an average peak-to-valley height R_{z} of from about 200 to 400 nm, where no additional backing coating is applied to this side. The above-mentioned R_{z} values can be achieved by known means during the production of the substrate, for example by incorporation of pigments of suitable size and geometry.

In order to obtain particularly tailored mechanical properties of the recording medium, a plurality of different polymer compositions can be coextruded as a multiple layer, preferably in one operation. Optionally, the polymeric substrate can be provided with a thin adhesion-promoting layer, whose thickness is in general less than 1 μm, before application of the magnetic layer. The composition of such adhesion-promoting layers is known from the prior art.

b. Magnetic Layer

The magnetic recording layer preferably contains at least one ferromagnetic powder, more preferably a metallic pigment or alloy pigment. These pigments contain Fe, Ni and/or Co as main components (for example, they contain Fe and Ni, Fe and Co, or Fe and Ni and Co as main components) and furthermore, if required, Al, Si, S, Sc, Ti, V, Cr, Cu, Y, Mo, Pd, Rh, Ag, Sn, Sb, Te, Ba, Ta, W, Re, Au, Hg, Pb, Bi, La, Ce, Pr, Nd, P, Mn, Zn, Co, Ni, Sr or B, individually or as a mixture. The pigments may have, on the surface, a protective coating to prevent oxidation or other harmful effects, or for improving the dispersibility. Highly coercive ferromagnetic iron oxides, chromium dioxide and ferrites, such as barium ferrite, are further non-limiting examples of suitable materials.

The metal powders and alloy powders are preferably acicular or spindle-shaped and generally have a BET surface area of about 40-90 m²/g. Usually, the axial length is not more than 200 nm and the length/width ratio is from 2 to 20. The coercive force generally is at least 100 kA/m and the saturation magnetization is from at least 100 to 180 emu/g. The metal powder or alloy may contain a small proportion of water or hydroxide as a nonmetallic fraction.

Barium ferrite is preferably tubular, with a mean particle size of from 20 nm to 120 nm and a length/width ratio of from 2 to 10.

The magnetic layer may contain a polymeric binder having a Tg which is below 60° C. and another one which has a Tg of more than 60° C. According to the invention, the glass transition temperature Tg is defined as the midpoint temperature determined according to ASTM D 3418-32 by differential thermal analysis (DSC) (cf. Ullmann's Encyclopedia of Industrial Chemistry, 5th edition, Vol. 21A, page 169, VCH Weinheim, 1992; and Zosel, Farbe und Lack 82 (1976), 125-134; and DIN 53765; the disclosures of the indicated passages of these documents are expressly incorporated by reference herein in their entireties).

Examples of binders having a Tg of less than 60° C. are, in particular, polyurethanes having ester or ether or carbonate groups and various rubbers. Examples of binders having a Tg of at least 55° C. are mentioned in more detail below. The binders preferably contain polar groups in order to increase the dispersing capability of the binders for further additives, in particular the pigments. Examples of such polar groups are —COOM, —SO₃M, —O—SO₃M, —O—PO₃—M, —PO(OM)₂, amino groups, ammonium groups, OH groups, SH groups and epoxy groups. In said polar groups, M represents hydrogen, alkali metal, in particular Na, Li or K, or ammonium.

Binders having a Tg of more than 60° C. can, for example, be selected from: vinyl (co)polymers, for example, vinyl chloride copolymers such as, e.g., vinyl chloride/vinyl acetate copolymers; vinyl chloride/vinylidene chloride copolymers and vinyl chloride/acrylonitrile copolymers, acrylate/acrylonitrile copolymers, acrylate/vinylidene chloride copolymers, acrylate/styrene copolymers, methacrylate/acrylonitrile copolymers, methacrylate/vinylidene chloride copolymers, methacrylate/styrene copolymers having ester, ether or carbonate groups, polyvinyl fluoride, vinylidene chloride/acrylonitrile copolymers, butadiene/acrylonitrile copolymers, styrene/butadiene copolymers, chlorovinyl ether/acrylate copolymers, polyvinyl acetal resins and polyvinylbutyral resins, urethane elastomers, nylon/silicone resins, nitrocellulose/polyamide resins, polyamide, polybutyrals, cellulose derivatives, polyester resins, amine resins, phenoxy resins and epoxy resins,. These binders can be used alone or in combination. Preferably, also the above-mentioned binders contain polar groups for increasing the dispersing capability thereof. Examples of suitable polar groups are the above-mentioned groups.

The magnetic layer preferably contains, as a further additive, at least one nonmagnetic pigment in finely divided form. Examples of such nonmagnetic pigments are

carbon black whose particle size may vary within relatively wide ranges, for example 0.015 μm -1.000 μm. The specific surface area of the carbon black is in general from approximately 20 m²/g to approximately 500 m²/g;

metal oxides, for example chromium oxide, alumina, cerium oxide, iron oxide, corundum, titanium dioxide, silica, tin oxide, magnesium oxide, tungsten oxide, zirconium oxide and zinc oxide, metal carbonates, metal sulfates, metal nitrides, metal carbides or metal sulfides. These pigments usually have a particle diameter of from 0.01 μm to 2.00 μm. They may be provided with an inorganic or organic coating. The shape of these pigments may, for example, be acicular, cubic, spherical or tabular. The pigments usually have a MOHS' hardness of at least 4. Pigments having a MOHS' hardness of at least 6 are particularly preferred, a preferred example thereof being Al₂O₃. These pigments perform in particular the function of the supporting pigment.

Furthermore, the magnetic layer may also contain further nonmagnetic additives. Non-limiting examples of these additives are one or more of the following:

Lubricants, for example fatty acids or fatty esters, fatty amides, silicone oils, fluorine-containing compounds or others. Preferred lubricants are selected from fatty acids of 11 to 22, preferably 11 to 18, carbon atoms and derivatives thereof. Non-limiting examples thereof are lauric, myristic, palmitic and stearic acid and derivatives thereof. Esters of the above fatty acids are derived, for example, from monohydric or polyhydric, preferably monohydric, aliphatic alcohols having a saturated, straight-chain or branched hydrocarbon radical of 1 to 6, preferably 1 to 4, carbon atoms. Non-limiting examples of such radicals are methyl, ethyl, isopropyl, n-propyl, n-butyl, isobutyl, sec-butyl, tert-butyl, n-pentyl or isopentyl, and furthermore n-hexyl. C₂-C₄-Alkyl esters of stearic, palmitic, myristic or lauric acid, in particular isobutyl or n-butyl stearate, palmitate, myristate and laurate or mixtures thereof, are specific non-limiting examples thereof. Further examples of usable lubricants are oxyalkylated esters of the above fatty acids, e.g. C₂-C₄-alkyl-di-C₂-C₄-alkylene glycol esters of stearic, palmitic, myristic and lauric acid, specific, non-limiting examples thereof being isobutyl and n-butyl-diethylene glycol stearate, palmitate, myristate and laurate.

Conductivity-increasing additives, such as barium sulfate, nitrates or the above-mentioned carbon blacks or graphite.

Crosslinking agents, for example polyisocyanates.

Dispersants, such as lecithin, oxo-containing fluorinated polyethers, as disclosed in DE-A-40 22 202, the disclosure of which is expressly incorporated by reference herein in its entirety, or amine-containing dispersants.

Surfactants, a large number of which are known from the prior art, for example oxo acids having a hydrophobic hydrocarbon group or salts thereof, particularly preferably phosphoric acid esters.

The dry thickness of the magnetic layer preferably is from approximately 3 μm to approximately 8 μm, particularly preferably from about 4 μm to about 5.5 μm. A dry thickness which is too small may result in a decrease of the saturation magnetization and, especially, the porosity, while an excessively large dry thickness of more than 8 μm may reduce the cohesiveness of the layer.

According to the invention, the recording medium has a specific surface porosity SSP of at least 80, preferably at least 90 cm²/cm². The SSP is defined as specific nitrogen adsorption per volume element, according to BET, of the magnetic layer (in cm²/cm³), multiplied by the layer thickness (in cm) of the magnetic layer. The Applicants have found, as also shown in the examples below, that the air cushion formed by pressing together master tape and copy tape disappears in this way by absorption in the porous magnetic layer and there is therefore direct contact between the magnetic recording layers of master tape and copy tape during the copying process, with the result that the magnetic recording on the copy tape has only few dropouts and affords a satisfactory image quality. This proves particularly useful when dirt particles continuously accumulate on the printwheel in the course of the copying process. In the case of master tapes having an SSP of at least 80 cm²/cm², markedly fewer dropouts are observed on the copy tape than in the case of a master tape having a correspondingly lower SSP.

The specific nitrogen adsorption per volume element is measured as follows: An adsorption vessel which contains the test specimen is compared with an empty adsorption vessel which serves as a zero sample, both vessels being filled with nitrogen. The nitrogen adsorption of the test specimen is measured and the porosity NAP, which includes a specific surface area, is calculated therefrom. This is accomplished by using an AREA-meter according to the BET method, a device which is also used for determining the specific surface area of, for example, pigments. This measurement indicates the amount of nitrogen which can be adsorbed by a specific volume element of the test specimen, in the present case of the recording medium, under the assumption of a monomolecular coverage of the surface and of a nonporous substrate (and an optionally present nonporous backing coating), so that it is the porosity of the magnetic layer that is measured. The unit, therefore, is m²/cm³ and, thus is dependent on the thickness of the magnetic layer. The SSP, i.e. the specific surface porosity, whose unit is cm²/cm^{2,} is obtained from the NAP by multiplication with the thickness of the magnetic layer.

Whereas, according to the invention, the lower limit of the SSP as defined above should be about 80 cm²/cm², preferably about 90 cm²/cm², the upper limit is primarily determined by the required layer cohesion, without which abrasion problems arise in the case of the recording medium. This upper limit generally is about 200 cm²/cm², preferably about 180 cm²/cm².

The Applicants have found that the above porosity can be achieved in various ways, for example through the porosity of the above-mentioned ingredients for the magnetic layer, in particular of the pigments. However, the porosity to be established can also be achieved by way of the production process to be described in more detail below, in particular by specific compaction or calendering of the finished magnetic recording medium.

c. Backing Coating

Optionally, a backing coating as substantially known from the prior art can be applied to the other side of the substrate, which faces away from the magnetic layer, for improving the mechanical properties of the novel recording medium, in particular for achieving the roughness necessary for the sprinter process. This backing coating may, for example, contain the following additives:

Binders as described above

Carbon black or carbon black mixtures

Surfactants, for example, those recited above for use in the magnetic layer

Lubricants, for example, those recited above for use in the magnetic layer

Crosslinking agents, e.g. polyisocyanates

Nonmagnetic pigments, as described above for the additives for the magnetic layer. For example, nonmagnetic pigments as mentioned in EP-A-0 869 480, the disclosure of which is expressly incorporated by reference herein in its entirety, are suitable.

The peak-to-valley height R_{z} of the backing coating should preferably be at least 200 nm and not more than 400 nm; the dry layer thickness preferably is from about 0.5 μm to 5.0 μm, more preferably from about 0.7 μm to 4.0 μm.

Production of Recording Medium

Dispersions are prepared in a manner known per se from the mandatory and any optional components described above.

The process for the preparation of suitable dispersions is known per se and may comprise a kneading stage, a dispersing stage and, optionally, a mixing stage, which can be provided before or after the foregoing stages. The respective stages may in each case comprise two or more operations. In the preparation of the composition, all starting materials, e.g., ferromagnetic powder, binders, carbon black, abrasives or supporting pigments, antistatic agents, lubricants, wetting agents and dispersants, and predominantly organic solvents can be added to the reactor right at the beginning of the process or later during the process. Examples of suitable solvents are tetrahydrofuran, methyl ethyl ketone, cyclohexanone, dioxane, acetone, esters such as, e.g., butyl, ethyl or methyl acetate, glycol monoethyl ether acetate, glycol, water and aromatic hydrocarbons. These solvents may be used individually or in combinations of two or more thereof.

The crosslinking agent and, optionally, a crosslinking catalyst are preferably added after the end of the preparation of the dispersion.

After polishing filtration through narrow-mesh filters having a size of not more than 5 μm, the dispersions are applied by way of a conventional coating apparatus at speeds in the customary range, oriented in the substantially longitudinal recording direction, dried and then subjected to a calender treatment and, optionally, a further surface smoothing treatment. “Substantially longitudinally oriented” means that the magnetic particles are present oriented in the recording direction substantially in the plane of the layer, but may also be arranged oriented obliquely to the plane of the layer.

For the production of the magnetic recording medium of the present invention, coating can be effected by means of, e.g., bar coaters, blade coaters, knife coaters, extrusion coaters, reverse-roll coaters and combinations thereof.

After the coating of the medium, drying and, optionally, calendering are carried out. Calendering is effected on conventional apparatuses by passing the dried webs between heated and polished rolls, with the use of a specific pressure and a defined temperature. Thereby the magnetic recording medium is smoothed and compacted.

In order to achieve the porosity according to the invention, a pressure of generally about 90 bar to not more than 110 bar is applied, which corresponds to a nip pressure of 210 daN/cm to 250 daN/cm. The calendering temperature usually ranges from about 70° C. to not more than 95° C., as also described in the examples below. An excessively high pressure and an excessively high calendering temperature reduce the SSP below the value according to the invention, while an excessively low pressure and an excessively low calendering temperature may not ensure a sufficient cohesion of the magnetic layer, which may result in abrasion.

The magnetic medium thus obtained may be slit into the form desired for use and subjected to the conventional electromagnetic and mechanical tests; moreover, the output level and the dropout behavior of a copy tape copied from the master tape in the fast copying process may be investigated.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting exemplary embodiments of the present invention, in which like reference numerals represent similar parts throughout the several views of the drawings, and wherein:

FIG. 1A shows, in the upper part, the essential features of the apparatus (sprinter) required for carrying out an anhysteretic fast copying process.

FIG. 1B shows an enlarged view of the section circled in the upper part of FIG. 1A.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

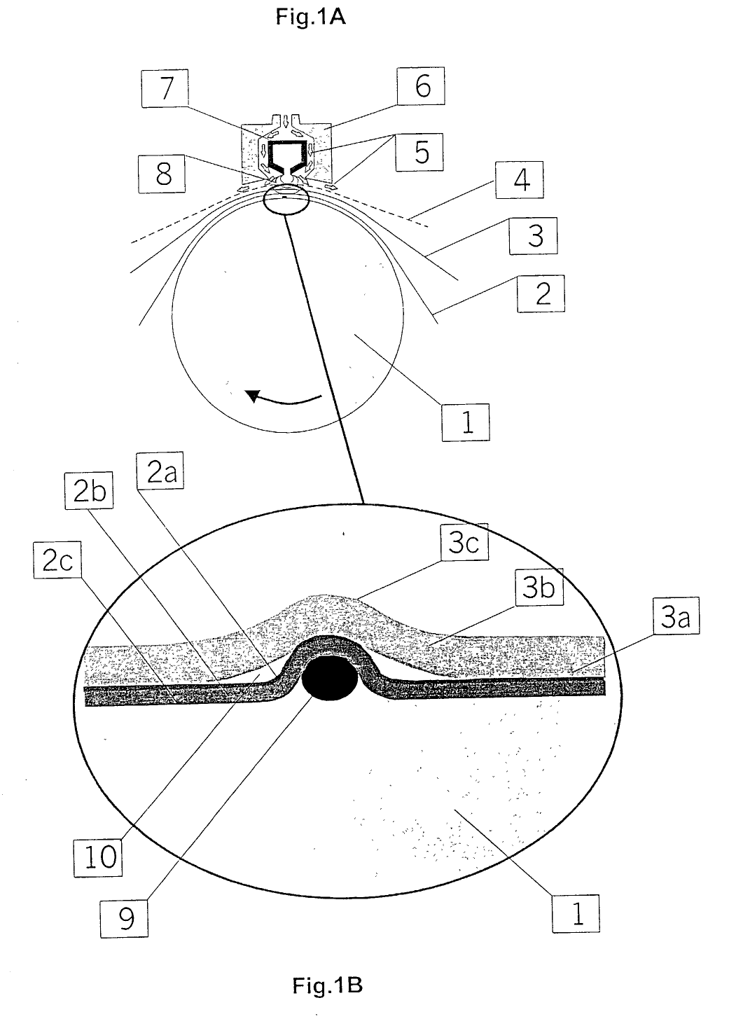

With reference to FIG. 1A, in the case of the loop sprinter, the copy tape 2 and, in contact with this, the master tape 3 run over the circumferential surface of a driven wheel 1 (printwheel), and both are driven at the same speed. Master tape and copy tape thus do not have a relative speed with respect to one another, but run over the printwheel 1 at the same speed.

In the shuttle sprinter, the printwheel 1 runs on an air cushion; copy tape and master tape 2, 3 are driven synchronously; for this purpose, the shuttle printer apparatus additionally has a driven drive tape 4, which drives the master tape 3 with one of its sides and, hence, also the copy tape 2.

Master tape and copy tape and, in the case of the shuttle printer, also the drive tape are pressed onto the printwheel 1 by compressed air 5 which emerges from outflow channels, in order to ensure very close contact for transfer of the magnetic information. The copy tape 2 is exposed to the magnetic field 8 of an electromagnet 6, 7.

With reference to FIG. 1B, numeral 2a denotes the magnetic layer of the copy tape 2, numeral 2b denotes the substrate and numeral 2c denotes a backing coating. Correspondingly, reference numerals 3a, 3b and 3c denote the magnetic layer, the substrate and the backing coating of the master tape 3, respectively. The magnetic layers 2a and 3a of the copy tape and of the master tape are thus transported in direct contact to one another. If a dirt particle 9 is present at a point on the surface of the printwheel 1, the transfer may be disturbed by the so-called tent effect, i.e. a type of cavity formation which is illustrated by reference numeral 10. As a result, the copy tape has a dropout at this point.

The examples which follow illustrate the invention without limiting same to said examples.

### EXAMPLE 1

A magnetic layer composition of the following composition (in parts by weight) was applied by way of a blade coater onto a 19.5 μm thick polyethylene terephthalate substrate, the surface whereof had an average peak-to-valley height R_{z} of 123 nm, measured using a perthometer, on both sides thereof.

| | |
|---|---|
| Metal pigment Co/Fe/Al/Y (Hc 162 kA/m) | 100 |
| α-Alumina, particle size 0.4 μm | 10 |
| Carbon black pigment, particle size 25 nm | 2 |
| Polyvinyl chloride copolymer having sulfonate groups | 13 |
| Polyesterurethane copolymer having sodium sulfonate groups | 8 |
| Phosphoric acid ester | 1 |
| Stearic acid | 2 |
| 2-Hexyl-1-decyl stearate | 1 |
| Diisocyanate | 4 |
| Tetrahydrofuran | 300 |
| Dioxane | 290 |

The above composition was applied at the dry layer thickness shown in the Table below. This Table also shows the calendering conditions, i.e. the temperature of the heated rolls and the calendering pressure. Also shown in the Table are the SSP and dropout values determined in each case for examples E1/3 to E1/6 according to the invention and comparative examples CE1/1 and 1/2. The dropout values were determined on a commercial magnetic tape which was copied as a copy tape at a speed of about 8 m/s on a loop sprinter.

The dropout values were determined in the following manner: in each case, two pieces of self-adhesive tape (roughly 1×1 mm, thickness 17 μm) were stuck as artificial dirt particle 9 (cf. FIGS. 1A and 1B) on the surface of the printwheel used for the copying process. The recording on the master tape was then copied onto the copy tape in the loop sprinter, after which the dropout values which occurred at the artificial defects on the copy tape were determined in the usual manner.

As is evident from the results summarized in the Table, in each case higher SSP values clearly correspond to lower dropout values.

Using a master tape according to example E1/3 of the present invention, it was possible to produce 13 000 copy tapes without impairment of the transfer properties, whereas only 3 800 copies could be produced using, as the master tape, a magnetic recording medium produced according to comparative example CE1/2.

### EXAMPLE 2

A magnetic recording medium which was produced according to Example 1 and had the values according to example E1/3 was used as a master tape for the thermomagnetic duplication process. By way of a thermomagnetic duplicating apparatus from Otari, the magnetic tape was driven over the apparatus together with a copy tape at a speed of 10 m/s. The magnetic pigment of the master tape had a Curie temperature of 1,043 K, and that of the copy tape had a Curie temperature of 387 K. Using this master tape, it was possible to produce several thousand copy tapes of satisfactory quality.

### EXAMPLE 3

The procedure of Example 1 was repeated, but the average peak-to-valley height R_{z} of the substrate on the other side opposite the magnetic layer was 230 nm. Such a tape also permitted the copying process on a shuttle sprinter at a copying speed of 4.5 m/s.

### EXAMPLE 4

The procedure of Example 1 was repeated, but a backing coating having the following composition (in parts by weight) was applied by way of a knife reverse-roll coater on the other side opposite the magnetic coating.

| | |
|---|---|
| Carbon black, particle size 30 nm | 75 |
| Silica, particle size 3 μm | 20 |
| Zinc ferrite | 5 |
| Phenoxy resin | 90 |
| Polyesterurethane copolymer having sulfonate groups | 70 |
| Polyester resin | 10 |
| Stearic acid | 2.5 |
| Polydimethylsiloxane | 1 |
| Diisocyanate | 80 |
| Tetrahydrofuran | 1,150 |
| Dioxane | 1,050 |

The backing coating had a dry thickness of 1.6 μm and an average peak-to-valley height R_{z} of 240 nm. A tape produced in this manner permitted the copying process also on a shuttle sprinter at a copying speed of 4.5 m/s, as in Example 2.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

TABLE

| | | | Magnetic | | | |
|---|---|---|---|---|---|---|
| Ex- | Calendar | Calendar | Layer | | Dropout | Dropout |
| am- | Pressure | Temp. | Thickness | SSP | 15 μs/ | 15 μs/ |
| ple | bar | ° C. | nm | cm²/cm² | 14 dB | 10 dB |
| CE | 105 | 90 | 3,900 | 47 | 570 | 842 |
| 1/1 | | | | | | |
| CE | 105 | 80 | 3,900 | 71 | 335 | 419 |
| 1/2 | | | | | | |
| E 1/3 | 105 | 70 | 4,100 | 81 | 276 | 334 |
| E 1/4 | 90 | 70 | 4,800 | 81 | 114 | 195 |
| E 1/5 | 90 | 70 | 5,500 | 152 | 17 | 24 |
| E 1/6 | 90 | 70 | 5,400 | 137 | 49 | 69 |

What is claimed is:

1. A tape-like magnetic medium, comprising a flexible substrate and, on a first side of the substrate, at least one magnetic layer which comprises magnetic pigment and polymeric binder, wherein the at least one magnetic layer has a thickness d_{M} of at least 3 μm and a specific surface porosity SSP of at least 80 cm²/cm², the SSP being the product of a specific nitrogen adsorption per volume element, according to BET, of the magnetic layer (in cm²/cm³) and the thickness d_{M} of the magnetic layer (in cm).

2. The tape-like magnetic medium of claim 1, wherein the SSP is at least 90 cm²/cm².

3. The tape-like magnetic medium of claim 1, wherein the SSP is not higher than 200 cm²/cm².

4. The tape-like magnetic medium of claim 2, wherein the SSP is not higher than about 180 cm²/cm².

5. The tape-like magnetic medium of claim 1, wherein the thickness d_{M} is not higher than approximately 8 μm.

6. The tape-like magnetic medium of claim 4, wherein the thickness d_{M} is approximately 4.0 μm to 5.5 μm.

7. The tape-like magnetic medium of claim 1, wherein the substrate has a thickness d_{T} of at least 15 μm.

8. The tape-like magnetic medium of claim 7, wherein the thickness d_{T} does not exceed approximately 30 μm.

9. The tape-like magnetic medium of claim 1, wherein a second side of the substrate which does not carry the at least one magnetic layer has an average peak-to-valley height R_{z} of approximately 200 nm to 400 nm.

10. The tape-like magnetic medium of claim 1, wherein a second side of the substrate which does not carry the at least one magnetic layer carries a backing coating which comprises pigment and polymeric binder.

11. The tape-like magnetic medium of claim 10, wherein the backing coating has an average peak-to-valley height R_{z} of at least 200 nm.

12. The tape-like magnetic medium of claim 11, wherein R_{z} does not exceed 400 nm.

13. The tape-like magnetic medium of claim 10, wherein the backing coating has a thickness d_{R} of at least 0.5 μm.

14. The tape-like magnetic medium of claim 10, wherein the backing coating has a thickness d_{R} of not higher than 5 μm.

15. The tape-like magnetic medium of claim 12, wherein the thickness d_{R} is approximately 0.7 μm to 4 μm.

16. The tape-like magnetic medium of claim 1, wherein the magnetic pigment is selected from metallic pigments, alloy pigments and mixtures thereof.

17. The tape-like magnetic medium of claim 16, wherein the magnetic pigment comprises at least one of Fe, Ni and Co.

18. The tape-like magnetic medium of claim 17, wherein the magnetic pigment further comprises at least one of Al, Si, S, Sc, Ti, V, Cr, Cu, Y, Mo, Pd, Rh, Ag, Sn, Sb, Te, Ba, Ta, W, Re, Au, Hg, Pb, Bi, La, Ce, Pr, Nd, P, Mn, Zn, Co, Ni, Sr and B.

19. The tape-like magnetic medium of claim 16, wherein the magnetic pigment has a BET surface area of approximately 40 m²/g to 90 m²/g.

20. The tape-like magnetic medium of claim 19, wherein the magnetic pigment has a coercive force of at least 100 kA/m.

21. The tape-like magnetic medium of claim 1, wherein the magnetic pigment has a saturation magnetization of approximately 100 emu/g to 180 emu/g.

22. The tape-like magnetic medium of claim 1, wherein the polymeric binder of the magnetic layer comprises at least one polymer having a glass transition temperature, Tg, which is lower than 60° C. and at least one polymer having a Tg which is higher than 60° C.

23. The tape-like magnetic medium of claim 16, wherein the magnetic layer further comprises at least one nonmagnetic pigment.

24. The tape-like magnetic medium of claim 23, wherein the nonmagnetic pigment is selected from carbon black, metal oxides, metal carbonates, metal sulfates, metal nitrides, metal carbides, metal sulfides and combinations thereof.

25. The tape-like magnetic medium of claim 1, wherein the SSP is approximately 90 cm²/cm² to 180 cm²/cm², the magnetic layer further comprises at least one nonmagnetic pigment and has a thickness d_{M} of about 4 μm to 5.5 μm, the substrate thickness d_{T} is about 15 μm to 30 μm, a second side of the substrate which does not carry the at least one magnetic layer carries a backing coating which comprises pigment and polymeric binder and has a thickness d_{R} of about 0.7 μm to 4 μm and an average peak-to-valley height R_{z} of approximately 200 nm to 400 nm, and the magnetic pigment has a BET surface area of about 40 m²/g to 90 m²/g, a coercive force of at least 100 kA/m, and a saturation magnetization of approximately 100 emu/g to 180 emu/g.

26. A process for the production of the tape-like magnetic medium of claim 1, comprising applying a magnetic coating composition comprising magnetic pigment and polymeric binder onto a first side of a flexible substrate and drying the coating composition, wherein the resultant material is subjected to calendering between pressure rolls at a pressure of not exceeding 110 bar.

27. The process of claim 26, wherein the pressure is at least 90 bar.

28. The process of claim 26, wherein a nip pressure of the pressure rolls is not higher than 250 daN/cm.

29. The process of claim 28, wherein the nip pressure is at least 210 daN/cm.

30. The process of claim 26, further comprising applying a backing coating onto a second side of the flexible substrate.

31. The process of claim 26, further comprising orienting the magnetic coating.

32. The process of claim 26, wherein the pressure rolls are heated, having a temperature not higher than 95° C.

33. A process for the production of a copy of a magnetic recording medium having information recorded thereon, wherein a master tape comprising a first magnetic layer and having information recorded thereon and a copy tape comprising a second magnetic layer are passed, at a speed of at least about 4 m/s and with contact of the first and second magnetic layers with one another, over a copying device, and wherein the copy tape is heated above its Curie temperature to copy information recorded on the master tape onto the copy tape.

34. The process of claim 33, wherein the speed is in the range of 4 m/s to 10 m/s.

35. The process of claim 34, wherein the master tape comprises a magnetic medium which comprises a substrate with a magnetic layer thereon, and wherein the magnetic layer comprises magnetic pigment and polymeric binder and has a thickness d_{M} of at least 3 μm and a specific surface porosity SSP of at least 80 cm²/cm², the SSP being the product of a specific nitrogen adsorption per volume element, according to BET, of the magnetic layer (in cm²/cm³) and the thickness d_{M} of the magnetic layer (in cm).

36. The process of claim 35, wherein the SSP is approximately 90 cm²/cm² to 180 cm²/cm².

37. The process of claim 35, wherein the thickness d_{M} does not exceed 8 μm.

38. The process of claim 37, wherein the substrate has a thickness d_{T} of about 15 μm to 30 μm.

39. A process for the production of a copy of a magnetic recording medium having information recorded thereon, wherein a master tape comprising a first magnetic layer and having information recorded thereon and a copy tape comprising a second magnetic layer are passed, at a speed of at least about 4 m/s and with contact of the first and second magnetic layers with one another, over a copying device, and wherein an external magnetic field whose strength is not higher than half the coercive force of the master tape is applied to the master tape and the copy tape to copy information recorded on the master tape onto the copy tape.

40. The process of claim 39, wherein the speed is in the range of about 4 m/s to 10 m/s.

41. The process of claim 39, wherein the copying device comprises a loop sprinter.

42. The process of claim 39, wherein the copying device comprises a shuttle sprinter.

43. The process of claim 39, wherein the master tape comprises a magnetic medium which comprises a substrate having a magnetic layer thereon, and wherein the magnetic layer comprises magnetic pigment and polymeric binder and has a thickness d_{M} of at least 3 μm and a specific surface porosity SSP of at least 80 cm²/cm², the SSP being the product of a specific nitrogen adsorption per volume element, according to BET, of the magnetic layer (in cm²/cm³) and the thickness d_{M} of the magnetic layer (in cm).

44. The process of claim 43, wherein the SSP is approximately 90 cm²/cm² to 180 cm²/cm².

45. The process of claim 44, wherein the thickness d_{M} does not exceed approximately 8 μm.

46. The process of claim 45, wherein the substrate has a thickness d_{T} of approximately 15 μm to 30 μm.
